(19) United States
(12) Patent Application Publication
(10) Pub. No.: US 2009/0030846 A1
(43) Pub. Date: Jan. 29, 2009

(54) SYSTEM AND METHOD FOR FACILITATING PAYMENT TO A PARTY NOT HAVING AN ACCOUNT WITH A FINANCIAL INSTITUTION

(75) Inventors: Eduardo Martinez-Miranda, Pasig City (PH); Eugene L. Enriquez, Pasig City (PH); Dennis B. Mendiola, New York, NY (US); MA. Rosario Peralta, Pasig City (PH)

Correspondence Address: INTELLECTUAL PROPERTY LAW GROUP LLP, 12 SOUTH FIRST STREET, SUITE 1205, SAN JOSE, CA, 95113, US

(73) Assignee: PAYSETTER PTE LTD, Pasig City, PH (PH)

(21) Appl. No.: 10/597,943

(22) PCT Filed: Apr. 19, 2004
(86) PCT No.: PCT/SG04/00099

§ 371 Date: Aug. 11, 2006

(30) Foreign Application Priority Data
Feb. 13, 2004 (PH) 1-2004-00064

(51) Int. Cl. G06Q 20/00; G06Q 10/00; H04L 9/32

(52) U.S. Cl. 705/72; 705/44; 705/40; 705/39; 705/30

(57) ABSTRACT

A system for facilitating payment to a party not having an account with a financial institution, including: a payments facilitator; and at least one account established by the payments facilitator with at least one financial institution. When a payer sends a communication message to the payments facilitator to make a payment to the party, the payments facilitator allocates one of the at least one accounts to the party and links the allocated account with a unique identifier assigned to the party. Payment is thereafter made by the payer to the allocated account. Preferably, the payment is an electronic payment. In a further arrangement of the invention there is a system for facilitating transfer of load between dealers and/or customers of a telecommunications carrier that can include the system already described.

### FIELD OF THE INVENTION

The present invention relates to a system and method for facilitating payment to a party not having an account with a financial institution. Ideally, the payment is an electronic payment.

In an alternate arrangement, the present invention relates to a system and method for facilitating transfer of stored value (“load”) between dealers and/or customers of a telecommunications carrier. The two systems are particularly adapted for use with mobile phones.

### BACKGROUND ART

The following discussion of the background of the invention is intended to facilitate an understanding of the invention. However, it should be appreciated that the discussion is not an acknowledgment or admission that any of the material referred to was published, known or part of the common general knowledge of the person skilled in the art in any jurisdiction as at the priority date of the application.

In some countries, people live on a day-to-day cash basis with little or no capacity for saving money. As a result, a significant portion of these people have no need to establish an account with a financial institution, such as a bank account. This limits the payment options that can be made to such a person and is thus an inhibitor to the spread of electronic payment services to such people.

Notwithstanding their economic state, a lot of the people referred to in the previous paragraph have mobile telephones which they typically pay for on a pre-paid basis. However, in some cases, even the lowest fixed load amount may be a stretch on the financial resources of the person concerned.

As a result, there have been a significant number of methods of adding load to pre-paid phone accounts developed to service such people, including scratch cards electronic loading and sachet loading—each having set lower fixed load amounts. However, such methods typically require the dealer to undergo a registration and approval process. In the latter arrangements, the dealer typically requires additional equipment, such as an additional mobile phone, special SIM card or point-of-sale terminal. These requirements, along with the general requirement for a bank account, means that people as already described typically cannot become dealers of load.

Accordingly, it is a primary object of the present invention to provide a system where electronic payments can be made to people who do not have an account with a financial institution. It is a secondary, optional, object of the present invention to provide a system whereby people who do not have an account with a financial institution can become dealers of load and can transfer load to like people (the “end-consumer”) in amounts set by the end-consumer.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is a system for facilitating payment to a party not having an account with a financial institution, including:
a payments facilitator; and
at least one account established by the payments facilitator with at least one financial institution, where, when a payer sends a communication message to the payments facilitator to make a payment to the party, the payments facilitator allocates one of the at least one accounts to the party and links the allocated account with a unique identifier assigned to the party, the payment thereafter being made by the payer to the allocated account. Preferably, the payment is an electronic payment.

Ideally, the payments facilitator is, or is associated with, a telecommunications carrier and the unique identifier assigned to the party is the party's telephone number. This may be the party's fixed or mobile telephone number.

Alternatively, the unique identifier may be a code or another destination address, such as the party's e-mail address.

The communication message may take a variety of forms, including Short Messaging Service message; e-mail; telephone call utilising DTMF signals; written communication sent by post; verbal communication. The communication message may also be encrypted.

The communication message may include a variety of information. In one arrangement, the communication message includes the unique identifier of the party, the amount to be transferred to the party and the unique identifier of the payer. In another arrangement, the communication message may include details of the account the payer wishes the payment to be made from.

In alternative arrangements, the destination address of the communication message may be associated with, or include, the unique identifier of the party and/or the amount to be transferred to the party. In such situations, the communication message may not include any information, may only include the amount to be transferred to the party, or may only include the unique identifier of the party (as appropriate).

Preferably, the payments facilitator includes a client database—the primary key of the client database being the unique identifiers of parties/payers alike. The payments facilitator can then use the client database to obtain financial account details of the payer and thus know the account the money is to be paid out of (and whether such account has sufficient credit to make payment).

Optionally, the payments facilitator may request that the payer confirm that the transfer is to proceed by means of a further communication message. The payer may then confirm the transfer by replying to the communication message with a PIN or password (which must match the PIN or password stored in the client database for confirmation to be completed). Confirmation may also need to be attended to within a predefined time period.

The payments facilitator may communicate with the party who has been paid to inform them that money has been transferred to them by the payer. This communication may also specify the amount transferred. The payments facilitator may also communicate with the payer to inform them that the money has been transferred to the party.

The party may also be informed that the money can be claimed by establishing a bank account with the at least one financial institution. When so established, and details of the established account are notified to the payments facilitator along with the unique identifier of the party, the payments facilitator instructs the financial institution to transfer the money stored on the party's behalf in the associated account having the corresponding unique identifier to the established account. In an ideal arrangement, the established account is also linked to the unique identifier of the party.

Preferably, each transfer is given a trace number to facilitate reconciliation and auditing.

Each account in the at least one account may be assigned a status description. The status description may be one of “unused”, “inactive” and “assigned”. A status description of unused represents the account as being one able to be assigned to a party. A status description of assigned represents the account as being one already assigned to a party. A status description of inactive means that the account has recently been assigned to a party. Setting a status description of inactive also allows time to ensure that all monetary value is cleared from the account and that any possible fraudulent acts made in connection with the account are dealt with.

In accordance with a second aspect of the present invention there is a payments facilitator for use in a system for facilitating payment to a party not having an account with a financial institution, the payment facilitator having established at least one account with at least one financial institution and where, upon receipt of a communications message from a payer to make payment to the party, operates to allocate one of the at least one accounts to the party and links the allocated account with a unique identifier assigned to the party, payment thereafter being directed by the payment facilitator to the party's allocated account.

Preferably, the payments facilitator is, or is associated with, a telecommunications carrier and the unique identifier assigned to the party is the party's telephone number. The unique identifier may, as alternatives, be a code or other destination address, such as the party's e-mail address.

The payments facilitator may operate to extract the unique identifier of the party, the amount to be transferred and the unique identifier of the payer from the communication message and/or the destination address to which the communication message is sent. Optionally, the payment facilitator may operate to extract details of the account the payer wishes the payment to be made from and effect direct that payment be made from the identified account.

Preferably, the payments facilitator includes a client database—the primary key of the client database being the unique identifiers of parties/payers alike. The payments facilitator operable to obtain financial account details of a payer from the client database by matching unique identifiers and checking that the payer has sufficient credit in their financial account to make payment.

Ideally, the payments facilitator operates to send a further communication message to the payer requesting confirmation that payment is to be made and operable to make payment on confirmation. The payments facilitator may be operable to confirm payment is to be made by matching a received PIN or password against a PIN or password stored in the client database.

The payments facilitator may, optionally, send a communications message to the party who has been paid on effecting transfer. The payments facilitator may also send a communications message to the payer on effecting transfer.

The payments facilitator may operate to transfer money from the allocated account to an account established by the party with the at least one financial institution upon receiving details of the established account.

Preferably, the payments facilitator allocates a trace number to each transfer processed.

More preferably, the payments facilitator assigns a status description to each account established with the at least one financial institution. The status description may be one of “unused”, “inactive” and “assigned”. The payments facilitator may operate to assign a status description of:
assigned: on allocation of the account to a party;
unused: where the account is available for allocation to a party; and
inactive: when the account has been allocated to a party within a previous predetermined time period.

In accordance with a third aspect of the present invention there is a method for facilitating payment to a party not having an account with a financial institution, comprising the steps of:
receiving a communication message from a payer representing a request to make a payment to a party;
allocating an account established with a financial institution to the party, said account not already being in the name of the party;
directing the payment to be made from the payer to the party to be made to the allocated account.

Preferably, the method includes the further step of:
identifying from either the communication message and/or a destination address to which the communication message is sent the following information:
   the unique identifier of the party;
   the unique identifier of the payer;
   the amount to be transferred.

More preferably, the method includes the further step of identifying from the communication message the account the payer wishes the payment to be made from.

Preferably, the method includes the step of checking the amount available to be transferred in the payer's account, the method continuing if the payer has sufficient amount to make payment.

Preferably, the method includes the step of requesting confirmation from the payer that the transfer is to proceed.

Preferably, the method includes the step of verifying confirmation by comparing a PIN or password provided by the payer as part of confirmation with a previously recorded PIN or password provided by the payer.

Preferably, the method includes the step of communicating with the party who has been paid to inform them that money has been transferred to them by the payer and/or the amount transferred. The method may also include the step of communicating with the payer to inform them that the money has been transferred.

The method may also include the steps of:
receiving details of an account established by the party with the financial institution; and
transferring money held in the allocated account to the established account.

Preferably, the method also includes the step of rendering a previously allocated account inactive for a predetermined period of time before allowing said account to be allocated to another party.

Preferably, the method includes the step of assigning a trace number to each transfer.

In accordance with a fourth aspect of the present invention there is a system for facilitating transfer of load between dealers and/or customers of a telecommunications carrier, including:
a mobile phone possessed by the dealer; and
at least one account associated with the mobile phone,
   where the amount accredited to each account is only available for load transfers and where the dealer transfers load to another dealer or customer by sending a communications message to a destination address, the amount to be transferred and a unique identifier of the receiving dealer or customer being able to be ascertained from either the communication message or the destination address.

Ideally, the destination address is a telephone number comprising a set shortcode number and the receiving dealer's or customer's mobile phone number. The receiving dealer or customer may make payment for the transfer of load either in legal tender or electronically, potentially in accordance with the system the subject of the first aspect of the invention.

The system may include a first B2B account and a second B2C account to allow for differentiation between transfers involving dealers (ie. B2B transfers) and transfers between dealers and customers (ie. B2C transfers). The shortcode number used to effect the transfer can be used as means of distinguishing whether the transfer is a B2B or a B2C transfer.

Ideally, the dealer buys load direct from the telecommunications carrier at a discounted rate. Alternatively, the dealer buys load from another dealer, with the discount provided by the telecommunications carrier is split between the two dealers.

The dealer is asked to configure their mobile phone. Configuration involves the dealer password protecting their phone and entering their name. This is done at the phone level and there is no requirement for the dealer to undergo a registration or approval process at the telecommunication carrier level.

Optionally, the dealer may be requested to confirm that the transfer is to proceed by means of a further communication message. The dealer may then confirm the transfer by replying to the communication message with a PIN or password (which must match the PIN or password stored in a confirmation database for confirmation to be completed). Confirmation may also need to be attended to within a predefined time period.

The dealer may receive a further communication message confirming that the transfer has been effected. This communication message may include details of the load balance credited to the dealer after effecting the transfer.

Preferably, each transfer is given a trace number to facilitate reconciliation and auditing.

The system may be modified to allow the dealer to effect transfers via a communication message in one of the following forms: e-mail; SMS message; telephone call utilising DTMF signals. The communication message may also be encrypted.

The role of telecommunications carrier may be delegated to a transfer facilitator who has commercial dealings with a telecommunications carrier.

In a preferred arrangement, the dealer may identify which of the linked accounts load is to be transferred from.

In accordance with a fifth aspect of the invention there is a dealer for use in a system for facilitating transfer of load between dealers and/or customers of a telecommunications carrier, the dealer in possession of a mobile phone having at least one account associated therewith, where the dealer transfers load to another dealer or customer by sending a communications message to a destination address, the amount to be transferred and a unique identifier of the receiving dealer or customer being able to be ascertained from either the communication message or the destination address.

Preferably, the dealer receives payment for the transfer of load either in legal tender or electronically or in accordance with the first aspect of the present invention.

Ideally, the dealer specifies which of the at lest one accounts associated with the mobile phone load is to be transferred from by means of the destination address the communication message is sent to.

The dealer may purchase the load direct from the telecommunications carrier at a discounted rate.

Ideally, the dealer configures the mobile phone by setting password protection preventing use of the mobile phone and, optionally, entering a name.

The dealer may send a further communication message confirming that the transfer is to proceed on receipt of a communication message requesting such confirmation. The further communication message may include a PIN or password and may need to be sent within a predetermined period of time.

In accordance with a sixth aspect of the invention there is a method for facilitating transfer of load between dealers and/or customers of a telecommunications carrier, comprising the steps of:
receiving a communications message from a dealer at a destination address
ascertaining the unique identifier of the receiving dealer or customer and the amount to be transferred from either the communication message and/or the destination address
transferring load from at least one account associated with a mobile phone possessed by the dealer equal to the amount to be transferred to the customer.

Preferably, the method includes facilitating payment to the dealer for the load in accordance with the first aspect of the invention.

Preferably, the method includes ascertaining from the destination address used to receive the communication message, the account associated with the mobile phone the amount to be transferred is to debited from.

Preferably, the method includes the step of selling load to the dealer at a discounted rate.

Preferably, the method includes the step of requesting the dealer to configure their mobile phone.

More preferably, the method includes the step of requesting the dealer to set a password or PIN for their mobile phone.

Preferably, the method includes the step of assigning a trace number to the transfer.

Preferably, the method includes the step of seeking confirmation from the dealer that the transfer is to proceed and, upon receiving such confirmation, transferring the load.

More preferably, the method includes the step of verifying confirmation by comparing a PIN or password provided by the payer as part of confirmation with a previously recorded PIN or password provided by the payer.

### BRIEF DESCRIPTION OF THE DRAWINGS

The invention will now be described with reference to the accompanying drawings, of which:

FIG. 1 is a schematic representation of a system for facilitating payment to a party not having an account with a financial institution.

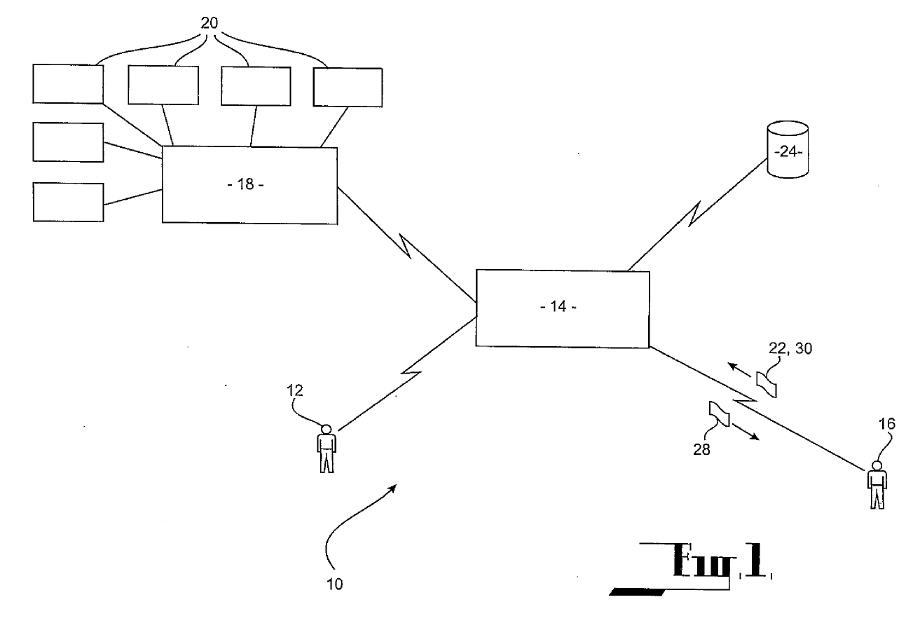

FIG. 2 is a schematic representation of a system for facilitating transfer of load between dealers and/or customers of a telecommunications carrier.

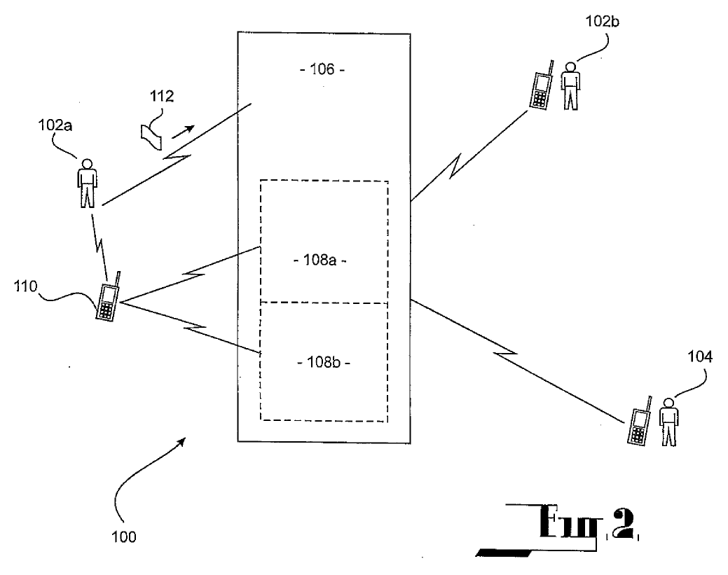

### DETAILED DESCRIPTION OF SPECIFIC EMBODIMENTS

In accordance with a first embodiment of the invention there is system 10 for facilitating electronic payment to a party 12 not having an account with a financial institution 18. The system 10 comprises:
a payments facilitator 14; and
a payer 16.

The financial institution 18 holds at least one account 20 in the name of the electronic payments facilitator 14.

The system 10 will now be described in use.

Payer 16 sends a communication message 22 to the payments facilitator 14. The communication message 22 includes the following information:
The unique identifier of the payer 16;
The amount to be transferred to the party 12; and
The unique identifier of the party 12.

On receipt of the communication message 22, the payments facilitator 14 parses the communication message 22 to identify the unique identifier of the payer 16, the unique identifier of the party 12 and the amount to be transferred.

The payments facilitator 14 then operates to check the unique identifier of the party 12 and the unique identifier of the payer 16 against a client database 24 (the unique identifier of the party 12/payer 14 being the primary key of the records stored in the client database 24). Upon identifying the payer's 16 corresponding record in client database 24, the payments facilitator 14 obtains details from the corresponding record of an associated account with a financial institution. Using these details, the payments facilitator 14 checks whether the payer 16 has sufficient credit in their associated account to effect the transfer.

If the payer 16 does not have sufficient credit in their associated account to effect the transfer, the payments facilitator 14 notifies the payer 16 of this fact.

If the payer 16 has sufficient credit in their associated account to effect the transfer, the payments facilitator 14 may, optionally, send a communications message 28 to the payer 16 requesting confirmation of the transfer. In such circumstances, confirmation of the transfer requires the payer 16 to send a further communication message 30 including a personal identification number (“PIN”) back to the payments facilitator 14. The payments facilitator 14 then compares the communicated PIN with a PIN stored in the payer's 16 corresponding record—confirmation occurring on a match between the two PINs.

If the payer 16 has sufficient credit in their associated account to effect the transfer and has entered a matching PIN, the payments facilitator 14 undertakes a check of the party's 12 corresponding record for details of an associated account with a financial institution. If so, the payments facilitator 14 operates to make an electronic payment equal to the amount to be transferred to the associated account.

If the corresponding record does not include details of an associated account, the payments facilitator 14 operates to associate the corresponding record with one of the payments facilitator's 14 accounts 20 having an assigned status of unused. This association is again based on the unique identifier of the party 12. The associated account 20 is then assigned a status of assigned. The payments facilitator 14 then operates to make an electronic payment equal to the amount to be transferred to the associated account 20. The payments facilitator 14 may then, optionally, notify the payer 16 that the money has been electronically transferred to the party 12.

At the same time, or shortly thereafter, the payments facilitator 14 notifies the party 12 that money has been electronically transferred to them and is being stored in the associated account 20 with the financial institution 18. The notice further informs the party 12 that the money can be claimed by establishing an account 26 with the financial institution 18 and associating that account 24 with their unique identifier recorded with the payments facilitator 14. Simultaneously, the payments facilitator 14 may, optionally, notify the payer 16 that the money has been electronically transferred to the party 12.

When the party 12 has established account 26 and associated the account 26 with their unique identifier recorded with the payments facilitator 14, the payments facilitator 14 then operates to instruct the financial institution 18 to transfer the amount stored in associated account 20 to account 26.

After transferring the amount stored in associated account 20 to account 26, the associated account 20 remains active, but is assigned a status of inactive. The payments facilitator 14 records the date of assigning an inactive status to the associated account 20. In this manner, the payments facilitator 14 can operate to automatically update the status of the associated account 20 to unused following a predetermined period of time from such date.

By having this pool of unused, inactive and assigned accounts 20 the payments facilitator 14 can reuse accounts as needed. The period of time that an account 20 must be assigned the status of inactive can vary, however, it must be of sufficient time to ensure that all monetary value is cleared from the account and to allow time to deal with any possible fraudulent acts made in connection with the account.

If the payments facilitator 14 does not recognise the unique identifier of the party 12, the payer 16 is sent a communications message informing them of this fact and asking them to check the unique identifier of the party 12 entered is correct.

By utilising this system, the payment facilitator 14 can generate revenue by setting transfer fees for operating this system, which may be debited from the amount to be paid to the party 12 either during the initial electronic payment transfer or later upon transfer to their established account 26. The payments facilitator 14 can generate a further revenue stream by appropriating the interest that accrues on unclaimed electronic payments stored in their accounts 20.

In accordance with a second embodiment of the invention, there is a system 100 for facilitating transfer of load between dealers 102 and/or customers 104 of a telecommunications carrier 106. The system 100 is best described in the context of its use.

A dealer 102 enters premises from which the telecommunications carrier 106 conducts business transfers and purchases load from the telecommunications carrier 106. Typically, the purchase of load is made in cash. Furthermore, the value of the load purchased is commonly between 13 and 15% greater than the cash price paid for the load (ie. the dealer 102 obtains a 13 to 15% commission).

The dealer 102 does not need to undergo a registration or approval process to purchase the load.

If not already attended to, on payment of the load:
dealer 102 is, optionally, prompted by SMS message, sent by the telecommunications carrier 106, to configure their phone. As part of the configuration process, the dealer 102 is asked to password protect their phone and, optionally, provide a name. By password protecting their phone, the dealer 102 had some protection from unauthorised transfers of load being made upon loss of possession of the phone.
the telecommunications carrier 106 links two accounts 108a, 108b to the dealer's 102 mobile phone 110. Account 108a is a B2B account and is available for transfer of load between dealers 102 only. Account 108b is a B2C account and is available for transfer of load from a dealer 102 to a customer 104 only. At the time of purchase, it is for the dealer 102 to decide how much load, if any, is to be credited to each account 108a, 108b.

It should be noted that the load stored in accounts 108a and 108b cannot be used by the dealer 102 to pay for calls or SMS messages. Thus, accounts 108a and 108b are separate from the dealer's 102 “working” account.

The dealer 102 is then able to canvas other dealers 102 and customers 104 to purchase load. In the example of a sale between dealers 102, the “selling” dealer will be referred to as dealer 102a, while the “purchasing” dealer will be referred to as dealer 102b.

If another dealer 102b wishes to purchase load from dealer 102a, dealer 102a operates to effect the transfer. This is achieved by sending an SMS message 112 to a predetermined telephone number. The predetermined telephone number, ideally, is a combination of:
a first shortcode (such as 103) issued by the telecommunications carrier 106 for the transfer of load between dealers 102;
and the other dealer's 102b mobile phone number.

The SMS message 112 identifies the amount of load to be transferred as agreed upon between dealer 102a and dealer 102b.

By sending the SMS message 112 to the first shortcode, the telecommunications carrier 106 knows that the transfer is to be between dealer's 102a account 108a and dealer's 102b account 108a, ie. a B2B transfer. The telecommunications carrier 106 then checks that account 108a has sufficient load to effect the transfer and, if so, operates to transfer the identified amount of load between the two accounts. Otherwise, the transfer is terminated.

Dealer 102b then operates to make payment to dealer 102a. Payment may be made in the form of cash or by means of electronic payment (in which case, if the dealer does not have an account with a financial institution, the electronic payment is processed in accordance with the first embodiment of the invention).

In this arrangement, a dealer 102a can form sub-dealership arrangements with other dealers 102b. The sub-dealership arrangements may allow for the dealer's 102a commission to be split between dealer 102a and dealer 102b. In such an arrangement, dealer 102b, like dealer 102a, has the option of selling load to customers 104 or to yet other dealers 102.

If a customer 104 wishes to purchase load from dealer 102, dealer 102 operates to effect the transfer. This is achieved by sending an SMS message 112 to a predetermined telephone number. The predetermined telephone number, ideally, is a combination of:
a second shortcode (such as 105) issued by the telecommunications carrier 106 for the transfer of load between dealer 102 and customer 104;
and the other customer's 104 mobile phone number. The SMS message 112 identifies the amount of load to be transferred as agreed upon between dealer 102 and customer 104.

By sending the SMS message 112 to the second shortcode, the telecommunications carrier 106 knows that the transfer is to be between a dealer's 102 account 108b and a customer's 104 working account. ie. a B2C transfer. The telecommunications carrier 106 then checks that account 108b has sufficient load to effect the transfer and, if so, operates to transfer the identified amount of load between the two accounts. Otherwise, the transfer is terminated.

Customer 104 then operates to make payment to dealer 102. Payment may be made in the form of cash or by means of electronic payment (in which case, if the dealer does not have an account with a financial institution, the electronic payment is processed in accordance with the first embodiment of the invention).

It should be appreciated by the person skilled in the art that the invention is not limited to the embodiments described. In particular, the invention described in the first embodiment of the invention can include the following modifications and/or additions:
The communication message may be adapted in a variety of ways. For example, the communication message may identify which of a plurality of accounts associated with the payer 16 the payer 16 wishes the payment to be made from. Payment processing is then modified in a manner as would be apparent to the person skilled in the art to ensure that payment is made from the identified associated account.
The communication message may also be adapted to simply include the unique identifier of the party 12. In such an arrangement, the unique identifier of the payer 16 can be obtained through automatic identification of the sending address, such as mobile phone number or e-mail address, used to send the communication message. Similarly, in such an arrangement, the amount to be transferred can be an attribute of, or suffix to, the destination address, such as phone number or e-mail address, to which the communication message is sent. To elaborate, a plurality of telephone lines could be used with each telephone line representing a different amount to be transferred. In such arrangement, the telephone number associated with the line could include as part of the dialled digits, the amount to be transferred (eg. shortcode 110 could be used by customers to transfer 110). This arrangement then provides the payer 16 with an easy reference to assist them in ensuring that they send the communication message using the telephone line corresponding to the amount that they wish to transfer.
The communication message may be yet further adapted to simply identify the amount to be transferred. In such an arrangement, the unique identifier of the payer 16 can be obtained through automatic identification of the sending address, such as mobile phone number or e-mail address, used to send the communication message. Similarly, in such an arrangement, the telephone number dialled may be a combination of a short code number and the unique identifier of the party 12 to whom the amount is to be transferred. Payments facilitator 14 then operates to parse the dialled telephone number to obtain the unique identifier of the party 12 and convert it into a native format for use in subsequent processing.
The methods of communication/notification may take a variety of forms including Short Messaging Service message; e-mail; telephone call utilising DTMF signals; written communication sent by post; verbal communication.
In situations where the payer 16 enters details of either the amount to be transferred and/or the unique identifier of the party 12 using the telephone keypad, the system as described may be adapted to allow the payer 16 to do so without needing to wait for prompts from an automated system designed to receive such information. Instead, the payer 16 may be able to split the dialled tones representing the amount to be transferred from the dialled tones representing the unique identifier of the party 12 using an appropriate separator key—such as the “*” or “#” keys.
The communication messages and notifications may be encrypted.

In such situations, at least the payments facilitator 16 must be equipped with means for encrypting and decrypting messages.
The unique identifier of the payer 16 and party 12 may be their destination address. Ideally, this is their mobile phone number. In such situations automatic caller identification or other mechanisms performing a similar function can be used to establish the unique identifier of the payer 16.
The payments facilitator 14 may form part of a larger computer system operated by a telecommunications carrier.
The payer 16 can confirm a transfer is to proceed by entry of a password, which may be alphabetic or alphanumeric.
Each transfer may be given a trace number to facilitate reconciliation and auditing.
The payer 16 and party 12 may associate their respective accounts with their respective financial institutions using the method described by the applicant in PCT/SG02/00172.
The party 12 may also associate their account 26 with their unique identifier recorded with the payments facilitator 14 by sending a communication message to the payments facilitator 14 including their unique identifier. This message may also include a PIN or password which is subsequently recorded in the party's corresponding record in database 24.

Further, the invention described in the second embodiment of the invention can include the following modifications and/or additions:
Yet additional accounts 108 may be linked to the dealer's 102 mobile phone.
The telecommunications carrier 106 may communicate with the dealer 102 on receiving a request to transfer load to verify the request. As part of the verification process, the dealer 102 may be asked to send a return message including a PIN or password that is matched against a stored PIN or password. If the communicated PIN/password matches the stored PIN/password the telecommunications carrier 106 proceeds to effect the transfer of load.
Upon completion of a transfer of load, the telecommunications carrier 106 may communicate with the dealer 102 to confirm that the transfer has been effected. Additionally, the communication may include details of the load balance credited to the dealer 102 after effecting the transfer.
Each transfer may be given a trace number to facilitate reconciliation and auditing.
The system may be implemented such that the dealer 102 can use e-mails communicated over a data communications network to facilitate the transfer of load.
The role of the telecommunications carrier 106 may be fulfilled by a transfer facilitator not being part of the telecommunications carrier 106. In such an arrangement the transfer facilitator may buy load form the telecommunications carrier in bulk for on-sale or act as agent for the telecommunications carrier authorised to sell load on its behalf.
The system may be implemented with use of a single shortcode. In such an arrangement, the dealer 102 may identify which of the linked accounts load is to be transferred from. Processing to transfer load is then modified in a manner as would be apparent to the person skilled in the art to ensure that load is transferred from the identified account.
The dealer 102 may only be required to send an SMS message to the specified shortcode. In this case, the telephone number of the load recipient (dealer 102 or customer 104) needs to be identified in the SMS message.
Some shortcodes can be assigned an amount to be transferred for convenience. In this case, all that is required is for the dealer 102 to call the shortcode.
The methods of communication/notification may take a variety of additional forms including e-mail; and a telephone call utilising DTMF signals.
In situations where the dealer 102 communicates required details via DTMF signals using the telephone keypad, the system as described may be adapted to allow the dealer 102 to do so without needing to wait for prompts from an automated system designed to receive such information. Instead, the dealer 102 may be able to split dialled tones representing required details from each other by using an appropriate separator key—such as the “8” or “#” keys.
The communication messages and notifications may be encrypted.

It should be yet further appreciated by the person skilled in the art that variations and combinations of features described above, not being alternatives or substitutes, can be combined to form yet further embodiments falling within the intended scope of the various embodiments of the invention.

1. A system for facilitating payment to a party not having an account with a financial institution, including:
a payments facilitator; and
at least one account established by the payments facilitator with at least one financial institution,
where, when a payer sends a communication message to the payments facilitator to make a payment to the party, the payments facilitator allocates one of the at least one accounts to the party and links the allocated account with a unique identifier assigned to the party, the payment thereafter being made by the payer to the allocated account.

2. A system for facilitating payment to a party not having an account with a financial institution according to claim 1, the payments facilitator being, or being associated with, a telecommunications carrier.

3. A system for facilitating payment according to any preceding claim, where the unique identifier assigned to the party being one of the following: the party's mobile phone number; the party's fixed telephone number; the party's e-mail address.

4. A system for facilitating payment according to any preceding claim, where the unique identifier of the party is included in, or can be attained from, the communication message or the destination address to which the communication message is sent.

5. A system for facilitating payment according to any preceding claim, where the unique identifier of the payer is included in, or can be attained from, the communication message or the destination address to which the communication message is sent.

6. A system for facilitating payment according to any preceding claim, where the amount to be paid is included in, or can be attained from, the communication message or the destination address to which the communication message is sent.

7. A system for facilitating payment according to any preceding claim, where the payments facilitator includes a client database, the primary key of records stored in the client database being the unique identifier of the party.

8. A system for facilitating payment according to claim 7, where each record in the client database includes financial account details of the party to which the record relates.

9. A system for facilitating payment according to any preceding claim, where the payments facilitator sends a first additional communication message to the payer requesting confirmation of the transfer and receives a second additional communication message from the payer confirming the transfer.

10. A system for facilitating payment according to claim 9, where the second additional communication message includes a PIN or password, the transfer proceeding if the communicated PIN or password matches a pre-stored PIN or password recorded for the payer.

11. A system for facilitating payment according to claim 9 or claim 10, where the payer is required to send the second additional communication message within a predetermined time period for the transfer to proceed.

12. A system for facilitating payment according to any preceding claim, where the payments facilitator sends a third additional communication message to the party informing them of the transfer.

13. A system for facilitating payment according to any preceding claim, where the payments facilitator sends a fourth additional communication message to the payer confirming the transfer has taken place.

14. A system for facilitating payment according to any preceding claim, where the fourth additional communication message includes text informing the party that the money can be claimed by establishing a bank account with the at least one financial institution.

15. A system for facilitating payment according to claim 14, where, when the party establishes an account with the at least one financial institution, the payments facilitator operates to transfer the money stored in the associated account to the established account.

16. A system for facilitating payment according to any preceding claim, where each transfer is assigned a trace number.

17. A system for facilitating payment according to claim 15, where the associated account is rendered inactive for a predetermined period after transferring the money to the established account, the associated account being available for association with a further party after the predetermined period.

18. A system for facilitating payment according to any preceding claim, where the communication messages take at least one of the following forms: Short Messaging Service message; e-mail; telephone call utilising DTMF signals; written communication sent by post; verbal communication.

19. A system for facilitating payment according to any preceding claim, where at least one of the communication messages is encrypted.

20. A payments facilitator for use in a system for facilitating payment to a party not having an account with a financial institution, having established at least one account with at least one financial institution where, upon receipt of a communications message from a payer to make payment to the party, operates to allocate one of the at least one account to the party and link the allocated account to a unique identifier assigned to the party, the payments facilitator thereafter operating to direct payment to the allocated account.

21. A payments facilitator according to claim 20, operable to assign the party's phone number as the unique identifier.

22. A payments facilitator according to claim 20 or claim 21, operable to extract the unique identifier of the party from the communication message and/or the destination address to which the communication message is sent.

23. A payments facilitator according to any one of claims 20 to 22, operable to extract the unique identifier of the payer from the communication message and/or the destination address to which the communication message is sent.

24. A payments facilitator according to any one of claims 20 to 23, operable to extract the amount to be transferred from the communication message and/or the destination address to which the communication message is sent.

25. A payments facilitator according to any one of claims 20 to 24, including a client database, the payments facilitator operable to obtain financial account details of a payer from the client database.

26. A payments facilitator according to any one of claims 20 to 25, operable to send a first additional communication message to the payer requesting confirmation that the payment is to be paid and operable to proceed with the payment on receiving a second additional communication message from the payer providing such confirmation.

27. A payments facilitator according to claim 26, operable to extract a PIN or password from the second additional communication message and, where the communicated PIN or password matches a pre-stored PIN or password fro the payer, proceeding with the payment.

28. A payments facilitator according to any one of claims 20 to 27, operable to send a third additional communication message to the payer confirming payment on effecting payment.

29. A payments facilitator according to any one of claims 20 to 28, operable to send a third additional communication message to the party confirming payment on effecting payment.

30. A payments facilitator according to any one of claims 20 to 29, operable to transfer money from the allocated account to an account established by the party with the at least one financial institution upon receiving details of the established account.

31. A payments facilitator according to any one of claims 20 to 30, operable to assign a trace number to each transfer processed.

32. A payments facilitator according to any one of claims 20 to 31, operable to render an associated account inactive for a predetermined period after transferring the money to the established account, the associated account being available for assigning to a further party after the predetermined period.

33. A method for facilitating payment to a party not having an account with a financial institution including the steps of:
receiving a communication message from a payer representing a request to make a payment to a party;
allocating an account established with a financial institution to the party, said account not already being in the name of the party;
directing the payment to be made from the payer to the party to be made to the allocated account.

34. A method for facilitating payment to a party not having an account with a financial institution according to claim 33, including the additional step of identifying the unique identifier of the party from either the communication message and/or a destination address to which the communication message is sent.

35. A method for facilitating payment to a party not having an account with a financial institution according to claim 33 or claim 34, including the additional step of identifying the unique identifier of the payer from either the communication message and/or a destination address to which the communication message is sent.

36. A method for facilitating payment to a party not having an account with a financial institution according to any one of claims 33 to 35, including the additional step of identifying the amount to be paid from either the communication message and/or a destination address to which the communication message is sent.

37. A method for facilitating payment to a party not having an account with a financial institution according to any one of claims 33 to 36, including the additional step of identifying from the communication message the account the payer wishes the payment to be made from.

38. A method for facilitating payment to a party not having an account with a financial institution according to any one of claims 33 to 37, including the step of checking the amount available to be transferred in the payer's account, the method continuing if the payer has sufficient amount to make payment.

39. A method for facilitating payment to a party not having an account with a financial institution according to any one of claims 33 to 38, including the step of requesting confirmation from the payer that the transfer is to proceed.

40. A method for facilitating payment to a party not having an account with a financial institution according to claim 39, including the step of verifying confirmation by comparing a PIN or password provided by the payer as part of confirmation with a previously recorded PIN or password provided by the payer.

41. A method for facilitating payment to a party not having an account with a financial institution according to any one of claims 33 to 40, including the step of communicating with the party who has been paid to inform them that money has been transferred to them by the payer and/or the amount transferred.

42. A method for facilitating payment to a party not having an account with a financial institution according to any one of claims 33 to 41, including the additional steps of:
receiving details of an account established by the party with the financial institution; and
transferring money held in the allocated account to the established account.

43. A method for facilitating payment to a party not having an account with a financial institution according to any one of claims 33 to 42, including the step of rendering a previously allocated account inactive for a predetermined period of time before allowing said account to be allocated to another party.

44. A method for facilitating payment to a party not having an account with a financial institution according to any one of claims 33 to 43, including the step of assigning a trace number to each transfer.

45.-47. (canceled)

48. A system for facilitating transfer of load between dealers and/or customers of a telecommunications carrier, including:
a mobile phone possessed by the dealer; and
at least one account associated with the mobile phone,
where the amount accredited to each account is only available for load transfers and where the dealer transfers load to another dealer or customer by sending a communications message to a destination address associated with the telecommunications carrier, the amount to be transferred and a unique identifier of the receiving dealer or customer being able to be ascertained from either the communication message or the destination address the communication message has been sent to.

49. A system for facilitating transfer of load between dealers and/or customers of a telecommunications carrier according to claim 48, where the destination address is a telephone number comprising a set shortcode number and the receiving dealer's or customer's mobile phone number.

50. A system for facilitating transfer of load between dealers and/or customers of a telecommunications carrier according to claim 48 or claim 49, where the receiving dealer or customer makes payment for the transfer of load either in legal tender or electronically.

51. A system for facilitating transfer of load between dealers and/or customers of a telecommunications carrier according to claim 48 or claim 49, including a B2B account for facilitating transfer between dealers, the amount of the B2B account only being available for load transfers.

52. A system for facilitating transfer of load between dealers and/or customers of a telecommunications carrier according to any one of claims 48 to 51, including a B2C account for facilitating transfer between dealer and customer, the amount of the B2C account only being available for load transfers.

53. A system for facilitating transfer of load between dealers and/or customers of a telecommunications carrier according to claim 51 and 52, where the shortcode number used to effect the transfer determines whether the transfer is to be made from the B2B account or the B2C account.

54. A system for facilitating transfer of load between dealers and/or customers of a telecommunications carrier according to any one of claims 48 to 53, where the dealer configures their mobile phone.

55. A system for facilitating transfer of load between dealers and/or customers of a telecommunications carrier according to any one of claims 48 to 54, where the dealer is requested to confirm that the transfer is to proceed by means of a further communication message, the dealer thereafter operable to send a confirmation communication message.

56. A system for facilitating transfer of load between dealers and/or customers of a telecommunications carrier according to claim 55, where the confirmation communication message includes a PIN or password and confirmation occurs if the communicated PIN or password matches a pre-stored PIN or password for the dealer.

57. A system for facilitating transfer of load between dealers and/or customers of a telecommunications carrier according to claim 55 or claim 56, where confirmation occurs if the confirmation communication message is sent within a predetermined time period.

58. A system for facilitating transfer of load between dealers and/or customers of a telecommunications carrier according to any one of claims 48 to 57, where a further communication message is sent to the dealer on effecting the transfer.

59. A system for facilitating transfer of load between dealers and/or customers of a telecommunications carrier according to claim 58, where the further communication message includes details of the load balance credited to the dealer after effecting the transfer.

60. A system for facilitating transfer of load between dealers and/or customers of a telecommunications carrier according to any one of claims 48 to 58, where a further communication message is sent to the dealer on effecting the transfer.

61. A system for facilitating transfer of load between dealers and/or customers of a telecommunications carrier according to any one of claims 48 to 60, where each transfer is given a trace number to facilitate reconciliation and auditing.

62. A system for facilitating transfer of load between dealers and/or customers of a telecommunications carrier according to any one of claims 48 to 61, excepting claim 53, where the dealer identifies which of the linked accounts load is to be transferred from 63. (original) A system for facilitating transfer of load between dealers and/or customers of a telecommunications carrier according to any one of claims 48 to 62, where the communication messages take at least one of the following forms: Short Messaging Service message; e-mail; telephone call utilising DTMF signals; written communication sent by post; verbal communication.

64. A system for facilitating transfer of load between dealers and/or customers of a telecommunications carrier according to any one of claims 48 to 63, where at least one of the communication messages is encrypted.

65. A dealer in a system for facilitating transfer of load between the dealer and another dealer and/or customer of a telecommunications carrier, the dealer in possession of a mobile phone having at least one account associated therewith, the dealer operable to send a communication message to a destination address associated with the telecommunications carrier, an amount to be transferred and a unique identifier of the receiving dealer or customer being included in either the communication message or the destination address, the telecommunications carrier thereafter operable to effect the transfer.

66. A dealer according to claim 65, operable to receive payment for the transfer of load either in legal tender or electronically.

67. A dealer according to claim 65 or claim 66, operable to specify which of the at least one accounts associated with the mobile phone the load is to be transferred from by means of the destination address the communication message is sent to.

68. A dealer according to any one of claims 65 to 67, operable to configure the mobile phone by setting password protection preventing use of the mobile phone.

69. A dealer according to any one of claims 65 to 68, operable to send a further communication message confirming that the transfer is to proceed on receipt of a communication message requesting such confirmation from the telecommunications carrier.

70. A dealer according to claim 69, operable to include a PIN or password in the further communication message, the PIN or password matching a PIN or password pre-stored with the telecommunications carrier.

71. A dealer according to claim 69 or claim 70, operable to send the further communication message within a predetermined time period to confirm the transfer is to proceed.

72. A telecommunications carrier in a system for facilitating transfer of load between their dealers and/or customers, operable to receive a communications message from a dealer at a destination address and determine the amount to be transferred and a unique identifier of the receiving dealer or customer from either the communication message or the destination address, the telecommunications carrier thereafter operable to transfer load from at least one account associated with a mobile phone of the dealer to an account associated with the receiving dealer or customer, as appropriate.

73. A telecommunications carrier according to claim 72 where the destination address is a telephone number comprising a set shortcode number and the receiving dealer's or customer's mobile phone number.

74. A telecommunications carrier according to claim 72 or claim 73, where the at least one account includes a B2B account for facilitating transfer between dealers, the amount of the B2B account only being available for load transfers.

75. A telecommunications carrier according to any one of claims 72 to 74, where the at least one account includes a B2C account for facilitating transfer between a dealer and a customer, the amount of the B2C account only being available for load transfers.

76. A telecommunications carrier according to claim 74 and claim 75, operable to determine whether load is to be transferred from the B2B account or the B2C account from the shortcode number the communication message is sent to.

77. A telecommunications carrier according to any one of claims 72 to 76, operable to send a first further communication message to the dealer prompting the dealer to configure their mobile phone.

78. A telecommunications carrier according to any one of claims 72 to 77, operable to send a second further communication message to the dealer requesting the dealer confirm that the transfer is to proceed and operable to receive a third further communication message from the dealer confirming that the transfer is to proceed.

79. A telecommunications carrier according to claim 78, operable to match a communicated PIN or password determined from the third further communication message to a pre-stored PIN or password for the dealer and proceeding with the transfer if there is a match.

80. A telecommunications carrier according to claim 78 or claim 79, operable to proceed with the transfer if the third further communication message is received within a predetermined time period.

81. A telecommunications carrier according to any one of claims 72 to 80, operable to send a fourth communication message to the dealer on effecting the transfer confirming that the transfer has been effected.

82. A telecommunications carrier according to any one of claims 72 to 81, operable to send a fifth communication message to the receiving dealer or customer on effecting the transfer confirming that the transfer has been effected.

83. A telecommunications carrier according to any one of claims 72 to 82, operable to allocate a trace number to each transfer.

84. A telecommunications carrier according to any one of claims 72 to 83, excepting claim 76, operable to identify which of the dealer's at least one accounts load is to be transferred from, from the communication message.

85. A method for facilitating transfer of load between dealers and/or customers of a telecommunications carrier, comprising the steps of:
receiving a communications message from a dealer at a destination address ascertaining the unique identifier of the receiving dealer or customer and the amount to be transferred from either the communication message and/or the destination address
transferring load from at least one account associated with a mobile phone possessed by the dealer equal to the amount to be transferred to the customer.

86. A method for facilitating transfer of load between dealers and/or customers of a telecommunications carrier according to claim 85, including the step of ascertaining from the destination address used to receive the communication message, the account associated with the mobile phone the amount to be transferred is to be debited from.

87. A method for facilitating transfer of load between dealers and/or customers of a telecommunications carrier according to claim 85 or claim 86, including the step of requesting the dealer to configure their mobile phone.

88. A method for facilitating transfer of load between dealers and/or customers of a telecommunications carrier according to claim 87, including the step of requesting the dealer to set a password or PIN for their mobile phone.

89. A method for facilitating transfer of load between dealers and/or customers of a telecommunications carrier according to any one of claims 85 to 88, including the step of assigning a trace number to the transfer.

90. A method for facilitating transfer of load between dealers and/or customers of a telecommunications carrier according to any one of claims 85 to 89, including the steps of seeking confirmation from the dealer that the transfer is to proceed and, upon receiving such confirmation, transferring the load.

91. A method for facilitating transfer of load between dealers and/or customers of a telecommunications carrier according to any one of claims 85 to 90, including the step of verifying confirmation by comparing a PIN or password provided by the payer as part of confirmation with a previously recorded PIN or password provided by the payer.

92.-95. (canceled)
